(19) United States
(12) Patent Application Publication
(10) Pub. No.: US 2008/0163345 A1
(43) Pub. Date: Jul. 3, 2008

(54) RFID TAG-BASED AUTHENTICATION FOR E-MAIL

(76) Inventors: Amanda J. Bauman, Austin, TX (US); Brian D. Bauman, Austin, TX (US); Michael P. Carlson, Austin, TX (US); Herman Rodriguez, Austin, TX (US)

Correspondence Address: The Brevetto Law Group, PLLC, 107 S. West Street, #765, Alexandria, VA, 22314, US

(21) Appl. No.: 11/619,205

(22) Filed: Jan. 3, 2007

(51) Int. Cl. H04L 9/32

(52) U.S. Cl. 726/5

(57) ABSTRACT

Methods 400 are provided for using RFIDs to aid in creating and documenting electronic e-mail communications. A communication device such as a computer system 200 capable of sending e-mail is configured with an RFID reader 215. When a user is composing an e-mail to send and the computer system 200 detects an RFID identity tag 120 of the user, an authentication content is attached to the e-mail. The authentication content attached to the e-mail helps to authenticate the identity of the user to the person receiving the e-mail.

### CROSS-REFERENCE TO RELATED APPLICATIONS

The present application claims priority from and incorporates by reference in its entirety the copending application “RF Tag-Based E-Mail Autogenerator” filed Aug. 17, 2006 and accorded U.S. Ser. No. 11/465,223.

### FIELD

Embodiments of the invention relate generally to e-mail communications, and more specifically to methods and systems that use RFID in the creation of e-mail.

### BACKGROUND

E-mail has become a widely accepted a form of communication. Most households and nearly all businesses regularly use e-mail to communicate, resulting in billions of e-mail messages being sent each day. Once an e-mail is sent it can be generally be delivered very quickly, often within a few seconds. Still, e-mail differs from face to face communications or telephone conversations in that there is no real-time interaction between the parties. This makes it difficult to verify the identity of the sender. When an e-mail is sent, the recipient has no way of knowing if it was actually sent by the person identified as the sender, or by another person at the sender's computer, or by someone spoofing the sender's identification. Recently, viruses have become a problem for e-mail applications. Such viruses have been known to infect an e-mail application and send e-mails to the contacts stored in the address book of the e-mail application (e.g., Microsoft Outlook). The recipients have no way of knowing that the e-mail came from a virus infecting the user's computer, until it is too late and the e-mail message has been opened.

Conventional systems have attempted to use an authentication certificate to sign an e-mail. But the certificates are controlled by the system and are automatically sent with outgoing e-mail. With conventional systems using authentication certificates there is no way of checking or verifying the identity of the person sending the e-mail. Thus, a drawback the current technology is that the sender can be spoofed in various ways or subjected to viruses. With the current technology the recipient has no way of knowing whether a received e-mail message originated from the intended sender or an impostor.

What is needed is a way to authenticate the identity of an e-mail sender.

### SUMMARY

Embodiments disclosed herein address the above stated needs by providing systems, methods and computer products for authenticating the identity of an e-mail sender. Various embodiments of the invention allow the recipient of an e-mail to authenticate that the user was physically present at the time the e-mail was sent. In at least some embodiments the user composes an authenticated e-mail to be sent from a communication device such as a computer system, a two-way pager, a cellular telephone, or other such communication device capable of sending e-mail. The various embodiments detect an identity tag proximate the communication device, compose the e-mail to be sent from the communication device, and associate the authentication content to the e-mail in response to the identity tag being detected.

In some embodiments the identity tag may be detected wirelessly, for example, with the identity tag including an RFID device configured to be detected by an RFID reader of the computer system or other communication device sending the e-mail. The sensitivity of the RFID reader may be adjusted in order to control the distance that the identity tag can be detected and thus be considered proximate. The identity tag may be provided by the organization that owns or services the communication device or another trusted entity such as an authorized issuer associated with the user of the communication device.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIGS. 1A and 1B respectively depict the front and back view of an exemplary identification tag with an RFID device;

FIG. 1C depicts exemplary communication devices which may be used to send e-mail in accordance with the invention;

FIG. 2 depicts an exemplary computer system for practicing at least one embodiment of the invention;

FIG. 3 depicts an exemplary method of setting up a computer system to operate according to various embodiments;

FIG. 4 depicts an exemplary method of sending an e-mail in accordance with various embodiments of the invention; and

FIG. 5 depicts an exemplary method of receiving an e-mail in accordance with various embodiments of the invention.

### DETAILED DESCRIPTION

The following description of various exemplary embodiments of the invention is illustrative in nature and is not intended to limit the invention, its application, or uses. The various embodiments disclosed herein provide systems, methods and computer products for authenticating the identity of an e-mail sender by embedding content in the e-mail that identifies the user in a manner that is capable of verification.

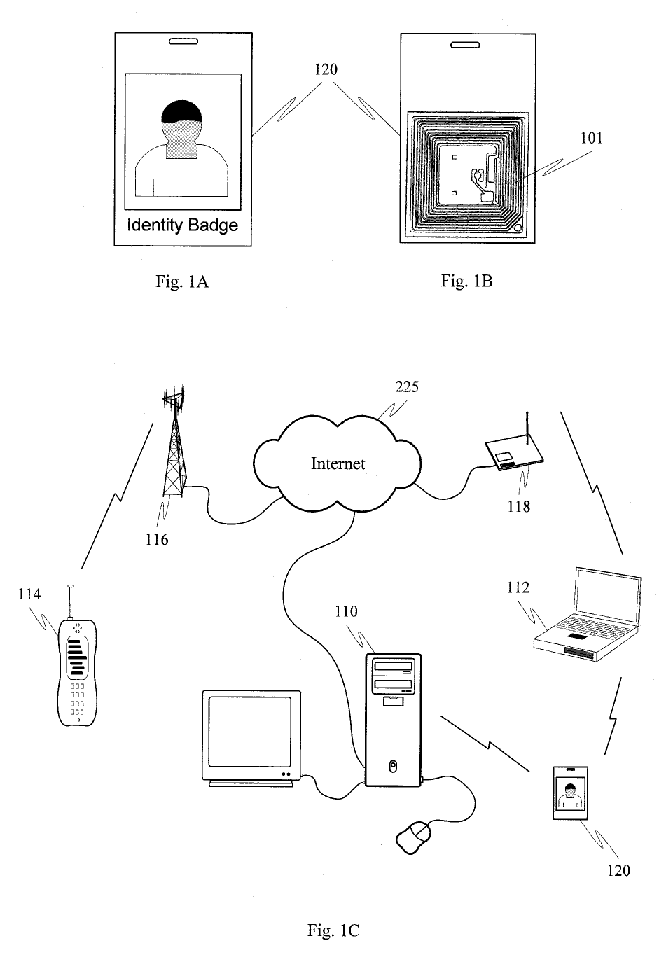

FIGS. 1A and 1B respectively depict the front and back views of an exemplary identification tag in the form of identity tag 120. The identity tag 120 may be configured to include a radio frequency identification (RFID) device 101, as shown in FIG. 1B. The RFID device 101 is a small device that responds to an RF interrogation signal with a RF response at a predetermined frequency. The response may contain data in addition to identification information. Various embodiments of the invention use an RFID device 101 to augment the identity of an e-mail sender. The RFID device 101 may be created or issued by submitting the proper credentials (e.g., government issued ID such as a drivers license or passport) to an authorized issuer. The authorized issuer may be a trusted authority such as a governmental agency (U.S. Post Office), Verisign, IBM, or other like type of organization. That authorized issuer may then provide the subscriber an authenticating RFID device 101 that will be used to augment the traditional ID badge when sending e-mail, if the RFID device 101 (or other wireless technology) is within proximity when sending the e-mail. The RFID device 101 may be part of the identity badge, or may be a stand-alone device in any of several form factors such as a wand, a badge, a dongle or other such configuration.

RFID Device 101 may be implemented to either provide a passive response or an active response. Passive RFID tags use the received energy from the interrogation signal to generate a response. The detection range for passive RFID tags has been increasing over time as advances have been made in the technology. The detection range is around 15 to 20 feet at present, but may be either more or less, depending upon the configuration. Active RFID tags tend to have a considerably longer range than passive tags because they generate and transmit a response signal using power from a power supply of the active RFID tag (e.g., a battery). Active tags may be queried up to 200 feet or more. Various embodiments of the present invention may use either active RFID tags or passive RFID tags, depending upon the constraints, costs and other engineering considerations of the implementation.

FIG. 1C depicts three exemplary communication devices which may be used to send e-mail in accordance with the invention. The figure shows a computer system 110, an e-mail-capable cellular telephone 114, and a laptop computer 112. Although the figure shows only these three devices, any type of communication device that can send e-mails may be capable of being configured for use in accordance with the present invention. For ease of illustrating the various embodiments, in this disclosure the invention is described in terms of a computer system being used, although it is understood that any type of communication device capable of sending e-mail can be configured to implement the invention.

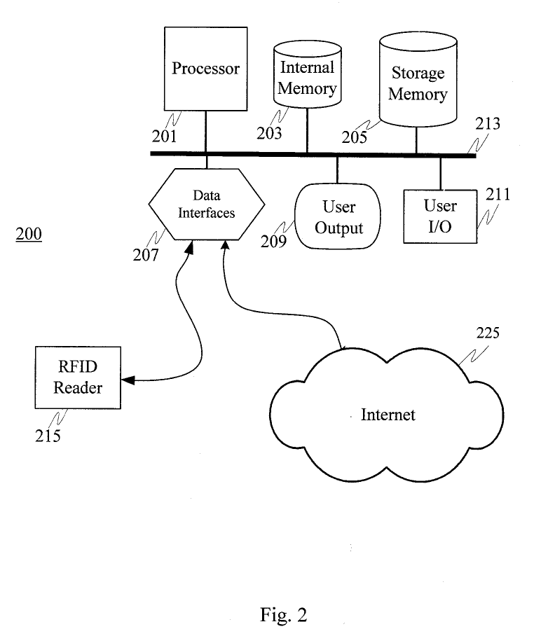

FIG. 1C shows the cellular telephone 114 being wirelessly connected to the Internet 225 via a cellular base station 116. The figure also shows the laptop computer 112 connected wirelessly to the Internet 225 via a wireless port 118. Computer system 110 is shown connected to the Internet 225 via a wired connection such as a coaxial cable system, a telephone line or other like type of network. Although the figure depicts the Internet 225 for use in sending and receiving e-mail, the various embodiments of the invention may be practiced over any communication link or network capable of sending and receiving e-mail. The computer system 110, the cellular telephone 114, and the laptop computer 112 each include, or are attached to, an RFID reader such as the RFID reader 215 of FIG. 2. An RFID reader is capable of detecting the presence of RFID tags in the proximity of the reader. RFID tags and RFID readers are discussed further in conjunction with FIG. 2.

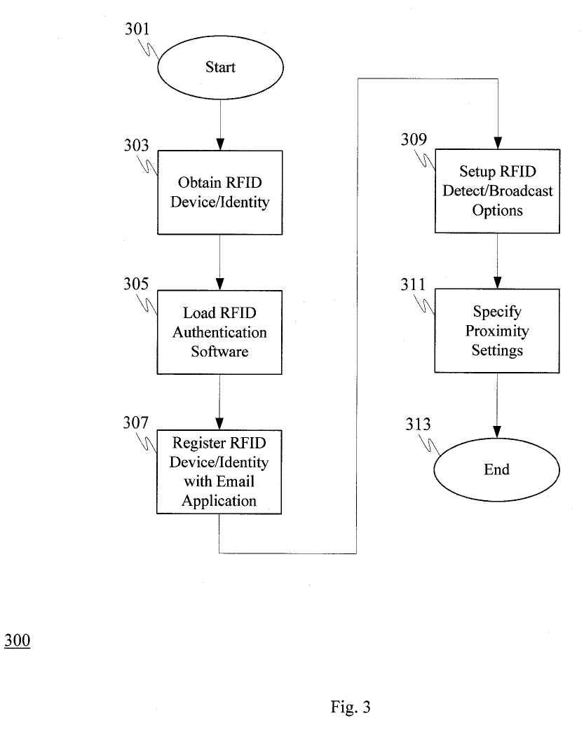

FIG. 2 depicts a computer system 200 which is capable of implementing various embodiments of the invention. The computer system 200 of FIG. 2 is an exemplary block diagram of the computer 110 of FIG. 1C. Other communication devices may be used with the invention, or other computer systems configured in a different manner. The computer system 200 may be configured in any number of ways but typically includes the components shown in the figure, although they may be known by different names or terms. The processor 201 contains circuitry or other logic capable of performing or controlling the processes, steps and activities involved in practicing the embodiments disclosed herein, for example, the activities depicted in FIGS. 3-5. In various embodiments the processor 201 may run a computer program or routine which performs one or more of the activities depicted in FIGS. 3-5. The processor 201 is generally embodied as a microprocessor, but may be an application specific integrated circuit (ASIC). In some embodiments the processor 201 may be a combination of two or more distributed processors, or other circuitry capable of carrying out commands or instructions such as those of a computer program.

The processor 201 is typically configured to communicate with an internal memory 203 via a bus 213 or other communication link. The internal memory 203 is often implemented as random access memory (RAM) and/or read only memory (ROM), but may be any form of memory or storage device suitable for storing data in the computer system 200. The storage memory 205 is used for storing computer software, operating systems, programs, routines, or code, including the instructions and data for carrying out activities of the various embodiments discussed herein. The storage memory 205 may be any of several types of storage devices including, for example, a hard disk, flash memory, RAM, ROM, registers, or removable media such as a magnetic or optical disk, or other storage medium known in the art. The memory 203 and 205 may comprise a combination of one or more storage devices or technologies.

The computer system 200 also includes one or more input/output (I/O) units such as user output 209 and user input 211. The user output 209 is often implemented as a monitor in the form of a liquid crystal display (LCD) screen or other type of display. The user output 209 also typically includes one or more audio speakers as well as the video monitor. The computer system 200 includes one or more user input devices 211. The user input devices 211 may include a keyboard, a mouse, a tablet surface and pen, a microphone and speech recognition routine, and/or other like types of input devices. The user output 209 and user input 211 may include other devices known to those of ordinary skill in the art and suitable for use with a computer system 200. Quite often the computer system 200 is configured to include data interface unit 207 for connecting to networks such as the Internet, to a local area network (LAN) or a wide area network (WAN), to the Public Switched Telephone System (PSTN) or to a wireless telephone network. Generally, e-mails from the computer system 200 are sent from the data interface via the Internet to a destination or addressee with another computer connected to the Internet. The data interface unit 207 may include a wired and/or wireless transmitter and receiver communicating in any of several standards and protocols known to those of ordinary skill in the art. Although the bus 213 is depicted as a single bus connecting all of the component parts of the system, the computer system 200 may include two or more separate buses, each connected to a subset of the system components.

The computer system 200 either includes, or is connected to, an RFID reader 215. The RFID reader 215 is configured to detect an RFID identity tag 120 in close proximity, that is, within its detection range. The RFID reader 215 may include circuitry configured to transmit an interrogation signal to other RFID tags in the vicinity, such as the RFID device 101 of FIG. 1B. Upon receiving the interrogation signal, the other RFID tags in the vicinity return a response to the reader, either actively or passively, as described above. The RFID tags and RFID reader circuitry used to implement the invention may be any of several types of RFID tags and readers, including, for example, the RFID tags and readers described in U.S. Patent Publication 2005/0049760 to Narayanaswami et al., and in U.S. Pat. No. 6,802,659 to Cremon et al., the contents of both documents being hereby incorporated by reference in their respective entireties.

The RFID tag, such as RFID device 101 of identity tag 120, to be used with RFID reader 215 may be an inductively coupled RFID tag which uses energy from the magnetic field generated by the RFID reader. The coil antenna of the RFID tag translates the magnetic energy into an electrical signal which is communicated to the logic of RFID reader 215. To respond to the interrogation signal of another reader, the RFID tag of reader 215 modulates the magnetic field, transmitting e-mail data back to the reader which sent the interrogation signal. The RFID tag used in RFID reader 215 may be implemented as a capacitively coupled RFID as the detection and transmission ranges increase for these devices. Capacitively coupled RFID tags do not have a coil antenna, instead using silicon circuitry to perform the function of the coil antenna.

Although FIG. 2 depicts a computer system 200 for practicing various embodiments, the invention may also be practiced using other devices capable of sending e-mail. For example, the various embodiments may be implemented using a cellular or wireless telephone, a personal digital assistant (PDA), a pager, a wireless navigation unit, an audio or video content download unit, a wireless gaming device, an inventory tracking unit, a dedicated device for word processing, text editing, computer aided design (CAD) or computer aided manufacturing (CAM), or any other like types of devices used for communicating, storing or processing information.

FIG. 3 depicts an exemplary method 300 of setting up a computer system or other communication device to operate according to various embodiments. The various embodiments may be implemented with any wired or wireless device capable of sending e-mails. However, to facilitate explanation of the invention, the various embodiments will be described herein in terms of being implemented using a computer system with Internet access and capable of sending e-mail, even though other implementations may be practiced.

The method begins at 301 and proceeds to 303 where an identity tag is procured. The identity tag may be an RFID identity tag such as that shown in FIGS. 1A and 1B. In some embodiments the identity tag may be obtained by submitting the proper credentials of a user to a trusted authority (e.g., a governmental agency such as the U.S. Post Office, Verisign, IBM, etc.). Once the identity of the user has been established, that trusted agency can physically provide the user, or subscriber, with an authenticating RFID identity tag. The identity tag can be used to augment the traditional ID when sending e-mail, if the RFID, or other wireless technology, is within proximity when sending e-mail. The identity tag issued by the trusted authority may be a piece of physical hardware such as the actual card depicted in FIGS. 1A and 1B. Alternatively, in some embodiments the trusted authority may encode an existing card brought in by the user, or provided by the user's employer, with a special identification code or algorithm. Once the RFID identity tag has been obtained the method proceeds to 305 to install the application software onto a communication device.

The installation of the application software in 305 may entail the application software being downloaded, or otherwise programmed into, the communication device. This may be done in any of several different manners, for example, by having the application software initially loaded onto the communication devices in the factory, purchased by the user from a brick-and-mortar store on floppy disks, downloaded from the Internet, or otherwise installed onto the communication device. The application software may be in the form of a software product or any computer readable program stored on an electronically readable medium (e.g., a compact disk, a DVD, a floppy disk, a dongle memory, a memory chip, or the like). The application software may either work in conjunction with an e-mail application or the application software may be part of a functioning e-mail application, including web based e-mail (e.g., Lotus Notes, Apple-mail, Microsoft Outlook or Outlook Express, Eudora, Mozilla Thunderbird, Pegasus, Claris, Blitzmail, Pronto Mail, Yahoo! Mail, or the like). In addition to the software application program itself, any drivers which may be needed are also loaded. For example, if a driver is needed for the program to communicate with the RFID receiver or detector, the driver is loaded in 305. After installing the application software of the e-mail authentication program the method proceeds to 307 to register the RFID identity tag with the application software.

In 307 the identity tag is registered with the application software. This allows the application software to recognize that the identity tag matches the default settings of the e-mail. For example, an e-mail application may be configured to automatically place a signature line at the end of an e-mail, tailored to include information of the user (e.g., the user's contact phone number, website, etc.). By registering the identity tag with the application software it can be verified that the person sending the e-mail matches the e-mail address and signature line inserted in the e-mail. In some embodiments, the identity tag of more than one person may be registered with the software application. Once the identity tag is registered with the application software the method proceeds to 309.

In 309 the various settings for the options and parameters of the application software are set up. This may be done at the time the application software is loaded on the machine, or the software settings may be altered at a later time by the user or administrator. The user may be presented with an option to either customize the application software themselves or install a default version of the configuration options. If the user opts to customize the configuration, then the system may present a set of options for setting up the application to the user. The options available to the user may include any type of features affecting the performance, operation or appearance of the application program. Such features may include options for setting up the menuing system, for specifying the buttons to be used in controlling the program, for configuring the RFID reader, and options for setting up the actual e-mail itself such as specifying how the authentication content is to be presented in the e-mail (e.g., as an attachment or as a notification within the e-mail). The settings also control the look and feel of the application, allowing the user to tailor the menus and controls for the application to be convenient for the user. For example, the setting may be configured to prompt a user with a query as to whether or not an e-mail is to include authentication content. Alternatively, the settings may be configured to automatically include authentication content with each e-mail rather than prompting the user each time an e-mail is created. Another setting may specify whether authentication content is to be included only in e-mails originally created on the user's computer or is also to be included in e-mails being forwarded or returned.

In 309 the user may select the form used for the authentication content. In some embodiments the authentication content may be a file (e.g., an executable file, a data file, a text file or the like) attached or embedded in the e-mail. In some embodiments the authentication content may be in the form of an Internet address—that is, a Uniform Resource Locator (URL)—which directs the person receiving the e-mail to a website where the sender's identification can be verified. In other embodiments the authentication content may be in the form of a watermark, a label, a seal, or any other type of information associated with the e-mail which verifies the sender's identification. There may be many other settings for the options and parameters of the application software specifying nearly every user-controllable aspect of the application program and the authentication content. Once the settings have been chosen the method proceeds to 311.

In 311 the user or administrator may specify the proximity settings for the system. The proximity settings affect the manner in which the detector (RFID reader 215) detects an identity tag (e.g., RFID identity tag 120). For example, the sensitivity of the reader may be adjusted to control the distance at which an identity tag is within the detection range and is considered proximate. By tweaking the reader sensitivity control the reader may be set to only detect identity tags which are very close (e.g., a few inches), or within typical operator range (e.g., within three feet or so) or in the same room or general location (e.g., within 20 feet or so). The proximity settings may also include the option to have an indicator of proximity such as an icon on a toolbar of the computer desktop which indicates the identity badge is within proximity, or an audible beep indicating that the identity badge has been detected and recognized. Once the proximity settings have been specified in 311 the method proceeds to 313 and ends.

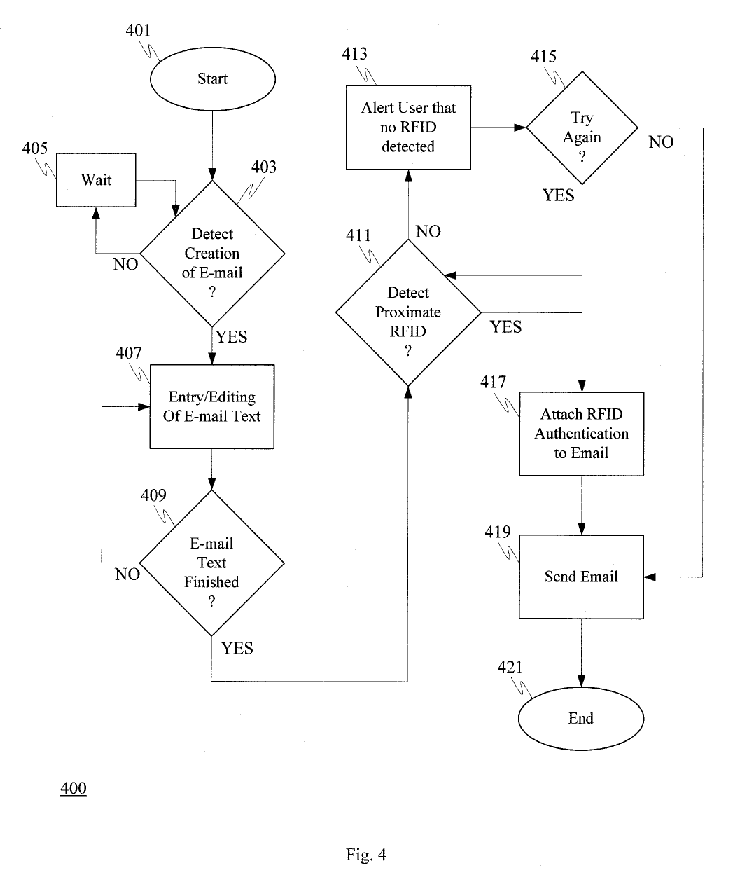

FIG. 4 depicts an exemplary method of sending an e-mail in accordance with various embodiments of the invention. The method begins at 401 and proceeds to 403 to determine whether a user has begun composing an e-mail. If no new e-mail is detected in 403 the method proceeds to 405 to loop around and wait until the creation of a new e-mail is detected. If a new e-mail is detected in 403 the method proceeds to 407 along the “YES” branch. In 407 the user composes a new e-mail by typing in text and/or adding attachments or other message content to the e-mail. In 409 it is determined whether or not the e-mail is finished. If the e-mail is not yet completed, the method loops back to 407 to finish composing the e-mail. Once it is determined in 409 that the e-mail has been completed the method proceeds to 411 along the “YES” branch.

In 411 it is determined whether the system has detected an identity tag—for example, the RFID identity tag 120 of FIG. 1A proximate the computer system being used to send the e-mail. The requirements for “proximity” may be adjusted by a user or administrator, as described above for 311 of FIG. 3. For example, the sensitivity of the RFID reader may be adjusted to only detect identity tags within three feet of the reader, or the sensitivity may be adjusted to detect tags within 20, or any other particular distance preferred by the user and within the capabilities of the RFID reader. In 411, if no identity tag has been detected the method proceeds from 411 to 413 along the “NO” branch. In 413 the system prompts the user with an alert (e.g., a pop-up window) that the e-mail is about to be sent without an authentication attachment for the e-mail. The system may inquire whether the user wants to send the e-mail with no authentication or try repositioning the identity tag to allow it to be detected, and the method proceeds to 415. If the user wants to try again, after repositioning the identity tag for better detection, the method proceeds from 415 back to 411 along the “YES” branch. If, however, the user prefers to send the e-mail without any authentication content then the method proceeds from 415 along the “NO” branch to 419 to send the e-mail. Back in 411, if it is determined that an identity tag has been detected the method proceeds from 411 to 417 along the “YES” branch.

In 417 the authentication content is attached to the e-mail. By “attached,” as this term is used herein, it is meant that the authentication content is included as an attachment to the e-mail, is encoded within, embedded in or otherwise associated with the e-mail. The authentication content may be a file attached to the e-mail or embedded within it or additional data encoded with the message, such as in the header fields of the e-mail. Such a file or header may be an executable file, a data file, a text file or other type of file configured to inform the person receiving e-mail that the sender of the e-mail has been authenticated. In some embodiments, instead of a file attachment the authentication content may be provided in the form of a URL Internet address which directs the person receiving the e-mail to a website where the sender's identification can be verified. The authentication content may alternatively be in the form of a watermark, a label, a seal, or any other type of information associated with the e-mail which verifies the sender's identification. The authentication content is attached in response to the detection of the identity tag and some aspect of the e-mail being composed. The detection of an identity card proximate to the system is a requirement for the authentication content to be attached. If an identity card has been detected, then the authentication content may be attached to an e-mail when the system determines that an e-mail is being composed, or other activity occurs during the creation of an e-mail (e.g., the user hits the “send” button to send an e-mail). Once the authentication content has been attached to the e-mail the method proceeds to 419 to send the e-mail. Upon sending the e-mail in 419, the method proceeds to 421 and ends.

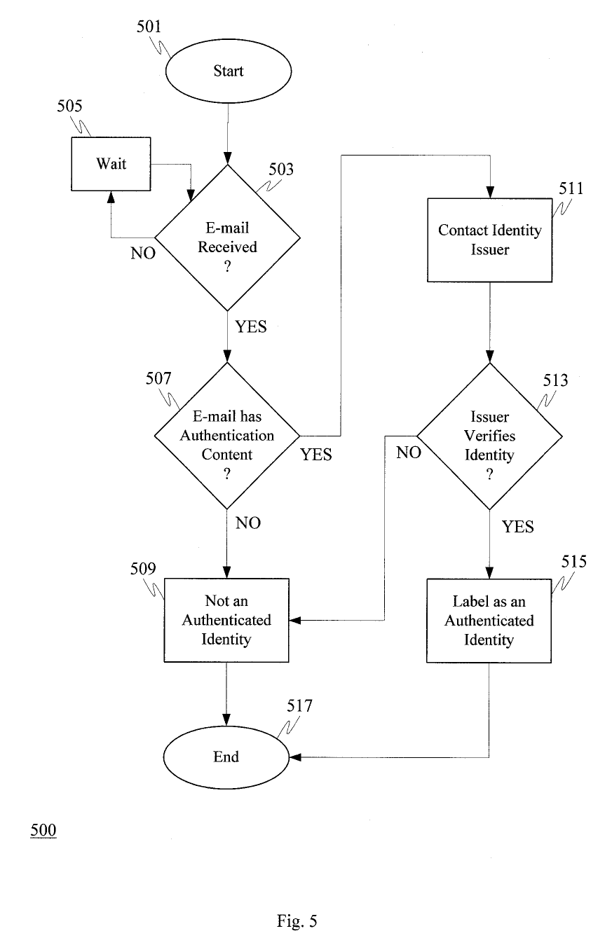

FIG. 5 depicts an exemplary method of receiving an e-mail in accordance with various embodiments of the invention. The method begins at 501 and proceeds to 503 to determine whether an e-mail has been received. If no new received e-mail is detected the method proceeds to 505 along the “NO” branch to wait until new e-mail is detected. If a newly received e-mail is detected in 503, the method proceeds to 507 along the “YES” branch.

In 507 it is determined whether the newly received e-mail has authentication content attached to it. If, in 507, it is determined that no authentication content is attached to the newly received e-mail the method proceeds along the “NO” branch to 509 and the e-mail is treated as a non-authenticated e-mail. However, if it is determined in 507 that there is authentication content attached to the received e-mail the method proceeds to 511 along the “YES” branch. In 511 application program contacts the issuer of the identity tag (e.g., a governmental agency such as the U.S. Post Office, Verisign, IBM, etc.) to verify that the authentication content is not fraudulent. In some embodiments the application software may prompt the user who has received the e-mail as to whether or not the issuer should be contacted to verify the identity of the sender in 511. In other embodiments the issuer is contacted automatically, for example, in response to the e-mail being received or else upon opening the e-mail. Contacting the issuer to verify the identity of the sender helps to prevent the authentication content from being forged. In some embodiments it is preferable that the URL or other contact information at which the issuer is contacted is stored in the computer system of the person receiving the e-mail, rather than being included in the authentication content of the received e-mail. This helps to prevent the issuer's URL from being spoofed. If the issuer's URL is included in the authentication content it may be encoded using a secure encryption code to avoid being altered or falsified.

Once the issuer has been contacted in 511 the method proceeds to 513 to determine whether the issuer verifies the sender's identity or not. If, in 513, the issuer cannot verify the sender's identity the method proceeds to 509 and the e-mail is treated as a non-authenticated e-mail. After 509 the method proceeds to 517 and ends. However, if it is determined back in 513 that the issuer can verify the identity of the sender based on the authentication content of the received e-mail, the method proceeds from 513 to 515 along the “YES” branch. In 515 a label or other indication of verification may be associated with the e-mail. The method then proceeds to 517 and ends. In some embodiments, the various functions outlined above for practicing the invention may be done either in the e-mail application program itself or by a separate application program working in conjunction with the e-mail application.

Various steps and activities may be included or excluded as described herein, or may be performed in a different order, with the rest of the activities still remaining within the scope of at least one exemplary embodiment. For example, a particular user receiving an e-mail may not care to contact the issuer to verify the authentication content. In such instances the blocks 511 and 513 of FIG. 5 would be omitted and the “YES” branch of 507 would proceed directly to 515. Another example of an activity that may be performed in a different order than shown in the figure is 411 of FIG. 4. The identity tag may be detected at any juncture of the process. Thus, 411 may, in some embodiments, be placed ahead of or behind 403 or 404, or elsewhere within the process. One other example of an activity that can occur at different junctures of the process is 417, the attachment of the authentication content to the e-mail. Block 409 may be performed at any time after block 411. It is expected that those of ordinary skill in the art may perform would know to change the order of the activities in other manners as well.

The processing units, processors and controllers described herein (e.g., processor 201 of FIG. 2) may be of any type capable of performing the stated functions and activities. For example, a processor may be embodied as a microprocessor, microcontroller, DSP, RISC processor, or any other type of processor that one of ordinary skill in the art would recognize as being capable of performing the functions described herein. A processing unit in accordance with at least one exemplary embodiment can operate computer software programs stored (embodied) on computer-readable medium, e.g. hard disk, CD, flash memory, ram, or other computer readable medium as recognized by one of ordinary skill in the art. The computer software programs can aid or perform the steps and activities described above. For example computer programs in accordance with at least one exemplary embodiment may include source code for performing the functions, activities, and/or steps described herein, and these are intended to lie within the scope of exemplary embodiments.

The use of the word “exemplary” in this disclosure is intended to mean that the embodiment or element so described serves as an example, instance, or illustration, and is not necessarily to be construed as preferred or advantageous over other embodiments or elements. The terms “software application” and/or “application program” as used herein, are intended to mean any software application or routine that performs or implements an embodiment of the invention. The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method of composing an authenticated e-mail to send from a communication device, the method comprising:
detecting an identity tag proximate the communication device;
composing the e-mail to be sent from the communication device; and
associating authentication content to the e-mail in response to the detection of the identity tag and in response to the composing of the e-mail.

2. The method of claim 1, wherein the communication device is a computer system.

3. The method of claim 2, wherein the identity tag is detected wirelessly.

4. The method of claim 2, wherein the identity tag comprises an RFID device and the computer system comprises an RFID reader; and
wherein the detection of the identity tag is done wirelessly between the RFID device and the RFID reader.

5. The method of claim 4, further comprising:
adjusting a sensitivity of the RFID reader to control a distance the identity tag is considered proximate and can be detected.

6. The method of claim 1, wherein the identity tag is issued by an authorized issuer and is associated with a user of the computer system.

7. The method of claim 1, further comprising:
checking for proximity of the identity tag upon determining that the e-mail is being composed.

8. A software product comprising an electronically readable medium including a program of instructions, wherein the program of instructions upon being executed on a device causes the device to:
detect an identity tag proximate a communication device;
composing an e-mail to be sent from the communication device; and
associate authentication content to the e-mail in response to the detection of the identity tag and in response to the composing of the e-mail.

9. The software product of claim 8, wherein the communication device is a computer system.

10. The method of claim 9, wherein the identity tag is detected wirelessly.

11. The method of claim 9, wherein the identity tag comprises an RFID device and the computer system comprises an RFID reader; and
wherein the detection of the identity tag is done wirelessly between the RFID device and the RFID reader.

12. The software product of claim 11, further causing the device to:
adjust a sensitivity of the RFID reader to control a distance the identity tag is considered proximate and can be detected.

13. The method of claim 8, wherein the identity tag is issued by an authorized issuer and is associated with a user of the computer system.

14. The software product of claim 8, further causing the device to:
check for proximity of the identity tag upon determining that the e-mail is being composed.

15. A communication device comprising:
an RFID reader configured to wirelessly detect an identity tag proximate the communication device;
a keyboard configured to accept inputs for composing an e-mail to be sent from the communication device; and
a processor configured to perform instructions associating authentication content to the e-mail in response to the detection of the identity tag and in response to the composing of the e-mail.

16. The communication device of claim 15, further comprising:
a memory suitable for storing the instructions associating the authentication content to the e-mail.

17. The communication device of claim 15, further comprising:
a control for adjusting a sensitivity of the RFID reader to control a distance the identity tag is considered proximate and can be detected.
